(19) United States
(12) Patent Application Publication
(10) Pub. No.: US 2002/0112420 A1
(43) Pub. Date: Aug. 22, 2002

(54) Multi-use door-frame structure

(76) Inventors: Toe Phomphakdy, Anaheim, CA (US); Marty Deland, Corona, CA (US)

Correspondence Address: OPPENHEIMER WOLFF & DONNELLY LLP, 38TH FLOOR, 2029 CENTURY PARK EAST, LOS ANGELES, CA, 90067-3024, US

(21) Appl. No.: 09/790,052

(22) Filed: Feb. 21, 2001

(51) Int. Cl. E06B 1/04

(52) U.S. Cl. 52/204.1

(57) ABSTRACT

A universal door frame includes a top jamb, strike jamb and hinge jamb. The strike jamb has two strike openings for receiving one full door or two half doors. The hinge jamb has four hinge locating areas for receiving two or four hinges. The profiles of the strike jamb and hinge jamb are identical so that they can be placed for position for a left hand door or a right hand door, and the door can be either a full door or a door made of an upper door and a lower door. The ends of the strike jamb and hinge jamb are identical such that either end can engage the ends of the top jamb to permit a door to swing inwardly or outwardly depending on the interrelationship of the strike jamb, hinge jamb and top jamb.

### BACKGROUND OF THE INVENTION

This invention relates to a universal door-frame, in particular for use with different doors. In particular the invention is concerned with a door frame for use with either a left hand door, a right hand door, inward swinging or outward swinging doors, or half doors, namely doors which are split so that there is an upper door and a lower door.

Other universal-type door frames are known. None of them have the facility to be used with as much application as the present invention. This invention is directed to overcoming the disadvantages of these known door frames and provides a novel door frame configuration, system and method.

### SUMMARY OF THE INVENTION

According to the invention there is provided a door frame for mounting any one of the doors having the following characteristics, namely a right hand door, a left hand door, an inward swinging door, an outward swinging door, a full door or a split upper and lower level door.

The door frame comprises a top jamb, a strike jamb and a hinge jamb. The strike jamb and the hinge jamb are symmetrical in cross section between the top and the bottom thereby permitting installation for a right hand door or a left hand door.

The strike jamb includes a first strike opening and a second strike opening. The two strike opening also allow the strike jamb to be turned upside down to allow for installation of an inward swinging door or an outward swinging door. The two openings are spaced apart such that the first strike opening is for a top door and the second strike opening is for a lower door. When there is a full door either the first strike opening or the second strike opening is operable.

The hinge jamb has hinge structures for hinge operation as two hinges for each of an upper door or lower door, respectively. Hinge receiving structures are located such that two of the receiving structures are in an upper half of the hinge jamb and two of the hinge receiving structures are in the lower half of the hinge jamb. Alternatively, the hinge receiving structures are such that at least two hinges operate with a full door.

The hinge jamb has two ends and the strike jamb has two ends. The profile of each of the ends is symmetrical thereby permitting the jambs to be used for a left hand door or a right hand door, or an inward swinging door or an outward swinging door. The top jamb engages either one of the respective ends of the hinge jamb and the strike jamb.

The profile of the hinge frame and the strike frame is generally a rectangular with an open side for receiving the outer frame structure. There is a rectilinear protrusion against which a door face is located.

The strike jamb and the hinge jamb include a notch at each end, the notch being for receiving a top jamb when placed in adjacent relationship with mating notches in the top jamb.

The strike jamb and hinge jamb configuration are such that operation with the top jamb can be universal. In this sense, each of the strike jamb and hinge jamb have the same notches at the bottom and the top, respectively. As such, the jambs can be located with a top jamb in a first upright location such that a door can open or swing, for instance, outwardly. Contrarily, the strike jamb and the hinge jamb can be located with a top jamb in the opposite or reverse location so that what would, in the first instance, be the bottoms of the strike jamb and the hinge jamb are the top of the strike jamb and the hinge jamb. What would normally have been the top of the strike jamb and the hinge jamb are now the bottom of the strike jamb and the hinge jamb. In this manner, the door would open or swing inwardly.

The arrangement of the invention with its component parts permits for the construct of a door as a single door or a dutch two-part door. Either one of those door constructs being one where the doors could open left or right, and either one of these doors being one where the door would open inwardly or outwardly. The construct of each of the components, namely the top jamb, the hinge jamb and the strike jamb permits for this universalness of this configuration.

The foregoing and other objects, features, and advantages of the present invention will be apparent from the following detailed description of the preferred embodiments which makes reference to several drawing figures.

### BRIEF DESCRIPTION OF THE DRAWINGS

FIG. 1 is an exploded view of a door frame with a split door, wherein there is shown an outer frame structure, a strike jamb, a top jamb and a hinge jamb for location in the outer frame.

FIG. 2 is a detailed view of a strike jamb.

FIG. 3 is a detailed view of a hinge jamb.

FIG. 4 is a perspective view of a split door.

FIG. 5 is a perspective view of a full door with locations for hinge structures.

FIG. 6 is a detailed view of the location area for a hinge structure on the door, and a representation of a hinge structure.

FIG. 7 is a perspective view of the detail of the notch at any one of the ends of the strike jamb or hinge jamb.

FIG. 8 is an end view of the strike jamb or hinge jamb.

FIG. 9a is a detail partial view of the one end of a top jamb turned through 90°.

FIG. 9b is a diagramatic relationship showing the interengagement of the top jamb with the notch of either one of the strike jamb or the hinge jamb. For illustration purposes, the strike jamb relationship is shown with the interengaging notches of the respective jambs.

FIG. 10 is a top view showing the top of a strike jamb, hinge jamb and the top jamb in phantom interengaging with notches in those respective jambs, and the door in a position to swing downwardly (outwardly) and towards the right, the hinge jamb being on the right hand side.

FIG. 11 is a top plan view showing the top of the strike jamb, hinge jamb and top jamb in phantom interengaging with notches in those respective jambs, and the hinge jamb being on the left such that the door would open downwardly (outwardly) and to the left.

FIG. 12 is a top view showing the top of the strike jamb, hinge jamb and top jamb in phantom interengaging with notches in those respective jambs and the door being directed to open upwardly (inwardly) and to the left. The configuration of FIG. 12 is opposite to that of FIG. 11 in the sense that the respective hinge jamb and strike jamb are turned respectively vertically upside down.

FIG. 13 is a top view showing the top of the strike jamb, hinge jamb and the top jamb in phantom interengaging with notches in respective jambs, and the door opening upwardly (inwardly) and to the right. The configuration of FIG. 13 is opposite the configuration of FIG. 10 in that the respective hinge jamb and strike jamb are turned “upside down” vertically.

### DETAILED DESCRIPTION OF THE PREFERRED EMBODIMENT

In the following description of the preferred embodiments reference is made to the accompanying drawings which form the part thereof, and in which are shown by way of illustration of specific embodiments in which the invention may be practiced. It is to be understood that other embodiments may be utilized and structural and functional changes may be made without departing from the scope of the present invention.

In FIG. 1 there is shown a door frame outer structure 10 for receiving a top jamb 11, strike jamb 12 and hinge jamb 13. The jambs 12 and 13 are symmetrical top to bottom so as to allow them to be installed as a left hand or right hand installation. There are two strike openings 20 and 21 on the jamb 11 so as to allow a double door 14 or a full door 15 to be operable. The two strike openings also allow the full or split doors to operate fully as either inward swinging doors or outward swinging doors. The full door 15 has four hinge locations 22, 23, 24, 25 to facilitate its being mounted as a full door. Alternatively, the dutch door 14 which has an upper door section 26 and a lower door section 27 each has two hinge locations so that each of the doors 26 and 27 can operate accordingly.

Thus, the universal hinge jamb 13 left or right handed (inward swinging or outward swinging) relative to four hinge receiving areas for hinge structures 30 and the universal strike jamb 12 has two strike openings. Each is symmetrical vertically and is adapted to be installed left or right handed relative to the outer frame 10.

The components 10, 11, 12, 13 and the selected doors 14 or 15 can be sent with an individual job to a door and can be installed as a full door, split door, right hand door or left hand door (inward swinging or outward swinging door) as a customer chooses. The hinge locations 22, 23, 24 and 25 on the door, the strike jamb 12 and the hinge jamb 13 and associated components all cooperate to provide for universal door constructions.

The profile in cross-section of each of the strike jamb 12 and the hinge jamb 13 is a substantially rectangular portion 31 with a rectalinear portion projection 32 for abutment with the side of a door. There is an opening 33 in one side of the rectangular portion 31. There is a first notch 34 at the foot and the top of each of the strike jamb 12 and the hinge jamb 13, and this is to facilitate engagement with a mating second notch 35 or construct in each end of the top jamb 11. Each of the ends of the jamb 11 has a notch 35 to receive the notch 34 of the respective strike jamb 12 and hinge jamb 13.

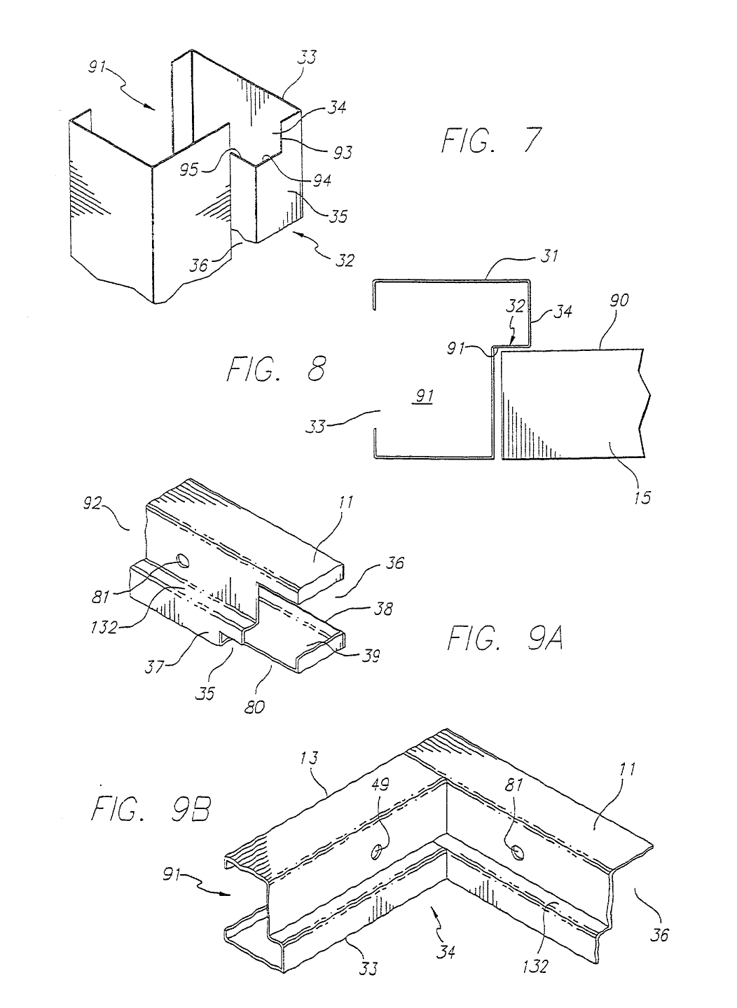

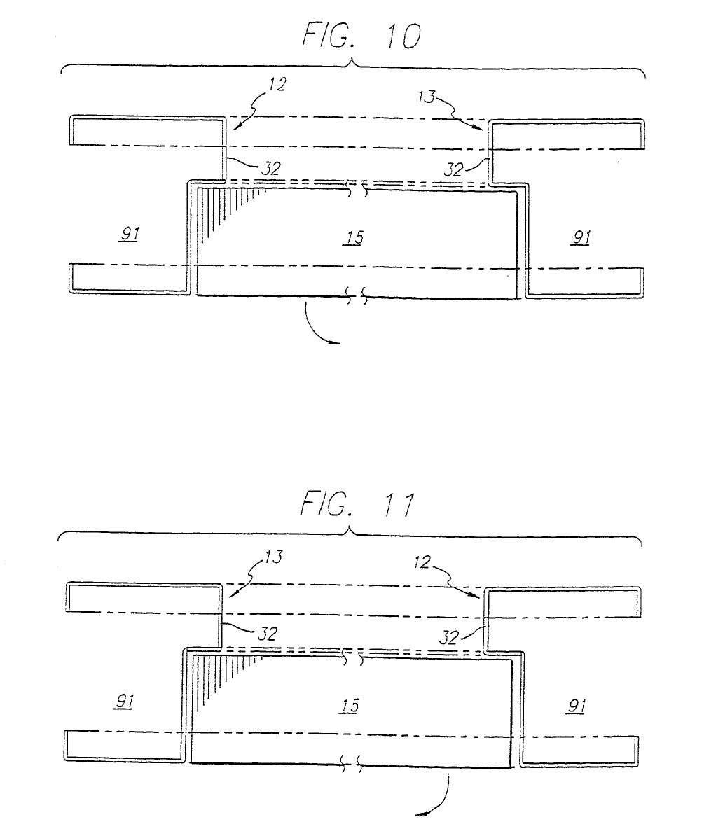

With reference to FIG. 7 each end of the strike jamb 12 and the hinge jamb 13 ends in the rectangular section 31 with the rectalinear protrusion 32. The notch formation 34 is formed in the rectalinear protrusion 32. Viewed in cross-section as seen in FIG. 8, there is the rectalinear section with one side having an open mouth 33. The rectalinear section 32 is on the opposite side of the open mouth 33. The notch 34 is formed between two walls 35 and 36 of the rectalinear section 32. This notch 34 is the first engagement means for interaction with the second engagement means being notch 35 in the top jamb 11. The notch 35 is shown in greater detail in FIG. 9. The top jamb 11 has a U-shape formation 36 with upstanding arms 37 and 38. The base of the U 39 has the cut out notch 35. The opposite end of limb 11 has the same notch formation 35. The notch formation 35 engages with the notch formation 34 so that the notches 35 positively engage with each of the top of the limbs 12 and 13. Notches 34 and 35 engage effectively.

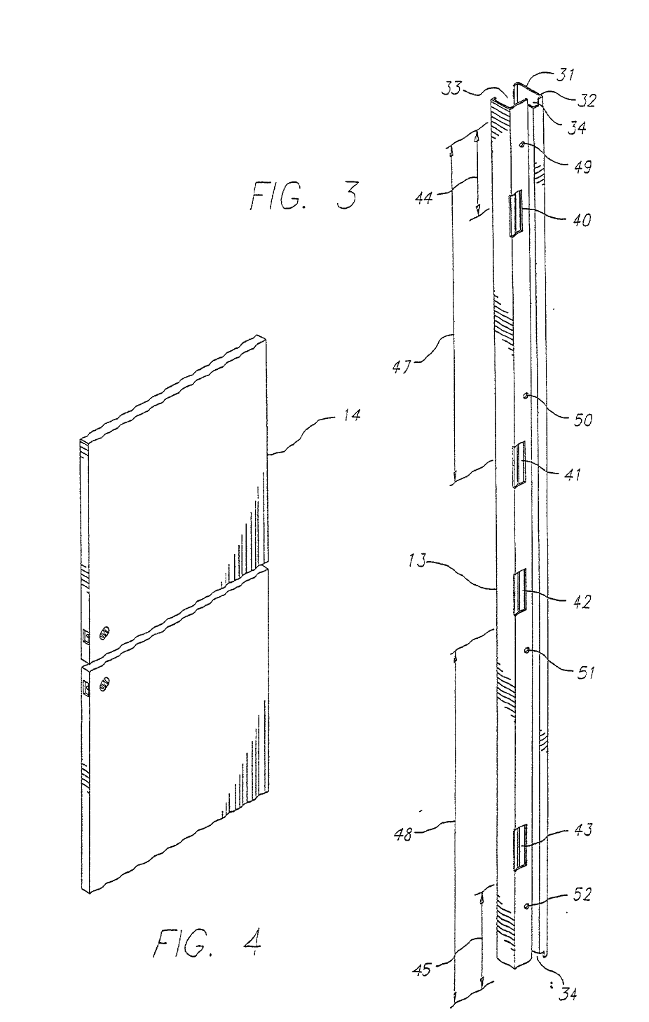

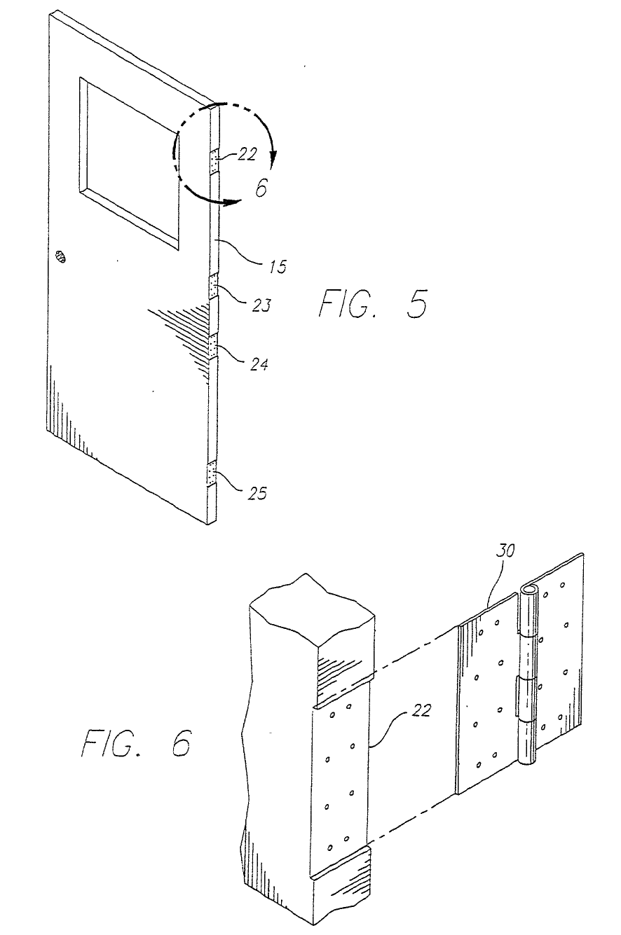

The relationship of the hinge receiving structures in the hinge jamb is fairly precisely determined. Two of the hinge receiving structures 40 and 41 are in the top half of the hinge jamb, and two of the structures 42 and 43 are in the bottom half of the structure. As can be seen in FIG. 3, if the hinge jamb was turned upside down for use with an opposite door, the hinges receiving structures 42 and 43 would be at the top, and hinge receiving structures 40 and 41 would be at the bottom. The hinge receiving structure 40 is spaced equally from the end 30 as the hinge receiving structure 43 is spaced equally from its respective end. Distance 44 at the one end is about 8 inches which is equal to the distance 45 at the opposite end. Between the distance 47 is equal to the distance 48 which is 32 inches. This makes the hinge jamb symmetrical from top to bottom and, as such the hinges 40 and 41 can be used for the top door 26, and hinges 42 and 43 can be used for the bottom door 27. Alternatively, all four hinge receiving structures can be used for the full door 15. Irrespective of whether this is a left hand full door or a right hand full door (inward swinging or outward swinging), this would operate as hinge receiving structures, and if the split door 26 and 27 is left hand or right hand, this would equally operate effectively. The hinge jamb also includes holes 49, 50, 51 and 52 which are countersunk to receive a Philips flat self-drilling screws. these are also located symmetrically in a similar fashion up and down the hinge jamb so that the hinge jamb can be used as indicated in FIG. 3 or turned upside down to be used in the opposite fashion. These counterholes 49, 50, 51 and 52 receive screws which are for engagement in receiving structures 53, 54, 55 and 56 in the outer frame 10. As can be seen, the spacing apart of the structures 53, 54, 55 and 56 corresponds with the positions of the holes 49, 50, 51 and 52.

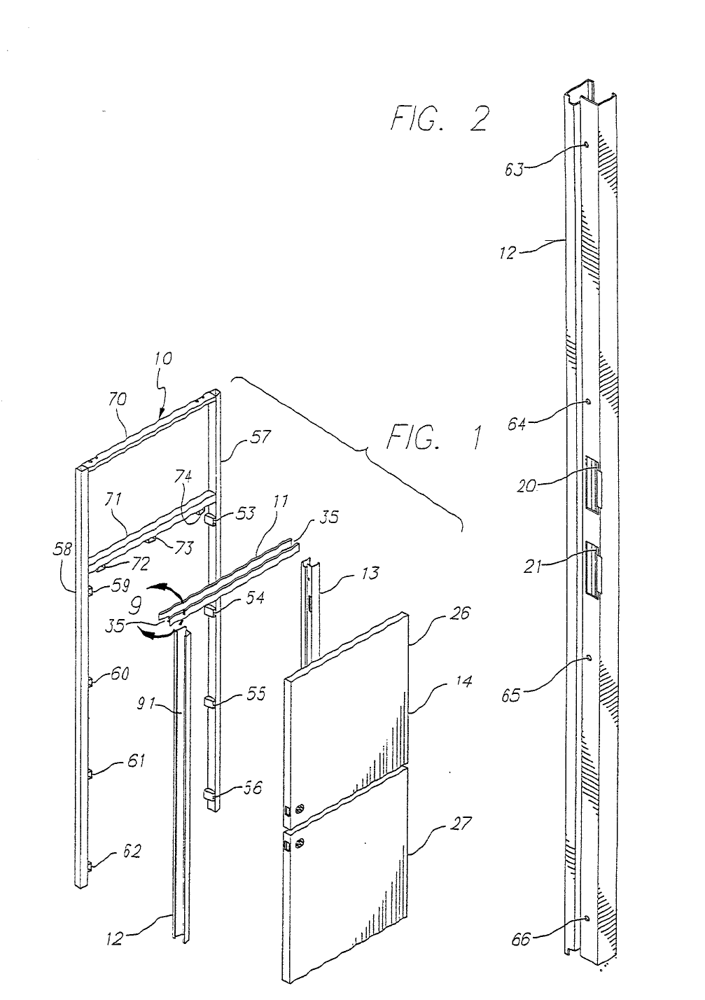

On the opposite side of the upright 57 of the frame structure 10 there is an upright 58 which has receiving structures 59, 60, 61 and 62. These structures are for receiving bolts or screws from the strike frame 12. Those bolts and screws would pass through the apertures 63, 64, 65 and 66 in the strike frame 12. The apertures 63 and 66 are equally spaced from the respective ends of the strike frame. Likewise, the apertures 64 and 65 are spaced symmetrically so that the strike jamb can be in the position shown in FIG. 2 or inverted for the opposite door configuration.

The outer door frame structure 10 includes a top cross bar 70 and an intermediate cross bar 71. The underneath of intermediate bar 71 includes formations. 72, 73 and 74. These formations are for receiving screws or bolts which pass through equidistantly spaced apertures in the base 80 of the top jamb 11. One such aperture 81 is shown in FIG. 9. This permits the top jamb to be secured to the cross bar 71.

As shown in FIG. 8, the face 90 of the door 15 engages the face 91 of the hinge jamb. Similarly, the face 90 would engage a similar face 91 of the strike jamb when the door is in the closed position. The outer door frame structure components 58 would fit within the space 91 of the strike component. The structure 57 would fit in the space 91 in the hinge jamb, and the substructure 71 would fit in a space 92 in the top jamb 11.

The notch 34 is defined so that the depth of the notch as indicated by arrow 93 is 0.625 inches. The length indicated by arrow 94 is 0.625 inches. The breadth indicated by arrow 95 is 0.625 inches. Thus, the notch is relatively a square configuration. This notch is equally a square configuration on the opposite end of the hinge jamb, and likewise the same size notch is on each end of the strike jamb. A mating notch configuration in size is formed on the top jamb 11.

The various holes and squares of all the bends in each of the strike jamb, hinge jamb and top jamb are critically formed and spaced appropriately so that there is symmetry in the structure so that the multiple users and configuration of the components can be set up so that the multi-use universal application of the jambs can be used so that the different door configurations can be applied. In the conventional configuration, the length of the strike jamb and the hinge jamb is 80 inches so as to accommodate a door of 79¼ inches. The length of the top jamb is 36 inches to accommodate a door of 35¾ inches.

The foregoing description of the preferred embodiments of the invention has been presented for the purposes of illustration and description. It is not intended to be exhaustive or to limit the invention to the precise form disclosed.

The invention includes the door frame 10 with a top jamb 11, a strike jamb 12 and a hinge jamb 13. The invention also includes a kit incorporating these components, and selectively additionally the outer door frame structure The invention also includes the method for forming a door frame and door using the kit components.

The strike jamb and the hinge jamb are symmetrical in cross section between the top and the bottom of each jamb. This permits installation for use with a right hand door or for use with a left hand door (either inward swinging or outward swinging) by locating the respective jambs in relative positions for selectively either the left hand door or the right hand door.

The strike jamb 12 includes a first strike opening and a second strike opening, the two strike openings being spaced apart. The hinge jamb has hinge receiving structures located such that two hinge receiving structures are located in an upper half of the hinge jamb and two hinge receiving structures are located in the lower half of the hinge jamb.

As such that the hinge operation is either:

(a) as hinges for each of an upper door or lower door respectively, or

(b) as hinges being for operation with a full door.

As illustrated in FIG. 10, the strike jamb 12 is on the left hand side and the hinge jamb 13 is on the right hand side. The door 15 is hinged to jamb 13 and opens downwardly and swings to the right. This could be the effective equivalent of a door opening outwardly and to the right. Comparatively, in FIG. 13, the strike jamb is on the left hand side and the hinge jamb is on the right hand side. The door 15 is hinged to the hinge jamb 13 and is directed to open upwardly and to the right. This could be the equivalent of a door opening inwardly and to the right. The difference in configurations between FIGS. 10 and 13 is that, respectively, each of the strike jamb 12 and hinge jamb 13 are turned vertically upside down. The notches at each respective end of the respective strike jamb and hinge jamb interengage with a top jamb in the manner illustrated in FIG. 9b. The notches at each end of the respective strike jamb and hinge jamb are the same so as to permit for this universalness of application. In the configuration as well, the top jamb is also reversed in a position as illustrated in FIGS. 10 and 13. Thus, in FIG. 10 the top jamb is constructed so that the portion against which the door 15 rests is at the top of the representation. In FIG. 13 the portion against which the door rests is as the bottom, and the door opening inwardly.

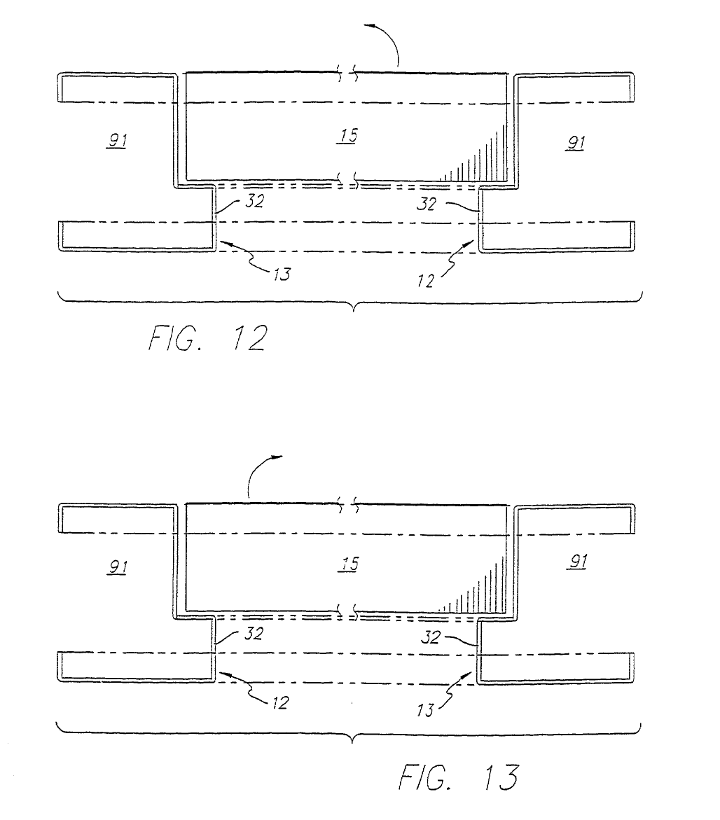

FIGS. 11 and 12 show the alternative configurations of the universal construction. In FIG. 11 the hinge jamb 13 is on the left and the strike jamb 12 is on the right. The top jamb is configured so that the rest portion against which door 15 closes is on the top portion. The door hinges on the left hand side and opens outwardly and to the left. Contrarily, in FIG. 12, the hinge jamb is on the left and the strike jamb is on the right. The top portion of the top jamb is shown relatively at the bottom such that the door 15 rests against that when closed. When open, the door 15 would swing leftwardly and inwardly as indicated by the respective arrows. In each of FIGS. 10, 11, 12 and 13 the arrows indicate that swing direction of the door from the closed position to the open position. As illustrated in FIGS. 11 and 12, the relative strike jamb 12 and hinge jamb 13 would be vertically reversed so that in FIG. 11 notches which are at the bottom are located in FIG. 12 at the top. The rectalinear protrusion 32 which extends from the rectangular section 31 over each of the respective strike jamb and hinge jamb can be seen to be respectively reversed. Thus, in FIG. 10 the protrusions 32 are at the top, and in FIG. 13 the protrusion 32 is at the bottom. In FIG. 11, the protrusion 32 is at the top, and in FIG. 12 the protrusion 32 is at the bottom. Similarly, in the top jamb 11 there is a protrusion 132 which is also reversed in each configuration. Thus, in FIG. 10 the protrusion 132 is at the top. And also it is at the top in FIG. 11. In FIGS. 12 and 13 the protrusion 132 is figuratively shown to be at the bottom respectively.

Many modifications and variations are possible in light of the above teaching. It is intended that the scope of the invention be limited not by this detailed description, but rather by the claims appended hereto.

What is claimed is:

1. A door frame for mounting selectively all of the following doors, the doors being a right hand door, a left hand door, a full door or a split upper door and lower door, wherein the door frame comprises
a top jamb, a strike jamb and a hinge jamb;
the strike jamb and the hinge jamb being symmetrical in cross section between the top and the bottom of each jamb thereby permitting installation for use with a right hand door or for use with a left hand door by locating the respective jambs in relative positions for selectively either the left hand door or the right hand door;
the strike jamb including a first strike opening and a second strike opening, the two strike openings being spaced apart such that the first strike opening is for use with a top door and the second strike opening is for use with a lower door, and wherein when there is a full door in the door frame either the first strike opening or the second strike opening is operable with the door; and
the hinge jamb having hinge receiving structures being located such that two of the receiving structures are in an upper half of the hinge jamb and two of the hinge receiving structures are in the lower half of the hinge jamb, such that the hinge operation is either:
(a) as two hinges for each of an upper door or lower door respectively, or
(b) as at least two of the hinges being for operation with a full door.

2. A door frame as claimed in claim 1 wherein the hinge jamb has two ends and the strike jamb has two ends, and wherein the side profile of each of the ends includes first end formations that are relatively symmetrical with each other thereby permitting the jambs to be used for a left hand door or a right hand door.

3. A door frame as claimed in claim 1 wherein the top jamb includes mating second formation for engagement with either one of the respective first formations of the hinge jamb and the strike jamb.

4. A door frame as claimed in claim 1 including an outer door frame structure wherein the cross sectional profile of the hinge frame and the strike frame is generally rectangular with an open side for location with an outer door frame structure, such that the frame structure fits with the jambs, and wherein there is a rectilinear-like protrusion against which a door face can be located.

5. A door frame as claimed in claim 1 wherein the ends of the strike jamb and the ends of the hinge jamb includes a notch, the notch being a first formation, the notch being for receiving a notch, being a second formation in the top jamb when the relative jambs are placed in assembled adjacent relationship together.

6. A door frame for mounting selectively all of the following doors, the doors being a right hand full door, a left hand full door, or a split upper right or left door and right or left lower door, wherein the door frame comprises
a top jamb, a strike jamb and a hinge jamb;
the strike jamb and the hinge jamb being symmetrical in cross section between the top and the bottom of each jamb thereby permitting installation for use with a right hand door or for use with a left hand door by locating the respective jambs in relative positions for selectively either the left hand door or the right hand door;
the strike jamb including a first strike opening and a second strike opening, the two strike openings being spaced apart such that the first strike opening is for use with a top door and the second strike opening is for use with a lower door, and wherein when there is a full door in the door frame either the first strike opening or the second strike opening is operable with the door; and
the hinge jamb having hinge receiving structures being located such that two of the receiving structures are in an upper half of the hinge jamb and two of the hinge receiving structures are in the lower half of the hinge jamb, such that the hinge operation is either:
(a) as two hinges for each of an upper door or lower door respectively, or
(b) as at least two of the hinges being for operation with a full door.

7. A door frame as claimed in claim 6 wherein the hinge jamb has two ends and the strike jamb has two ends, and wherein the side profile of each of the ends includes first end formations that are relatively symmetrical with each other thereby permitting the jambs to be used for a left hand door or a right hand door.

8. A door frame as claimed in claim 6 wherein the top jamb includes mating second formation for engagement with either one of the respective first formations of the hinge jamb and the strike jamb.

9. A door frame as claimed in claim 6 including an outer door frame structure wherein the cross sectional profile of the hinge frame and the strike frame is generally rectangular with an open side for location with an outer door frame structure, such that the frame structure fits with the jambs, and wherein there is a rectilinear-like protrusion against which a door face can be located.

10. A door frame as claimed in claim 6 wherein the ends of the strike jamb and the ends of the hinge jamb includes a notch, the notch being a first formation, the notch being for receiving a notch, being a second formation in the top jamb when the relative jambs are placed in assembled adjacent relationship together.

11. A door frame for mounting selectively different doors, wherein the door frame comprises
a top jamb, a strike jamb and a hinge jamb;
the strike jamb and the hinge jamb being symmetrical in cross section between the top and the bottom of each jamb thereby permitting installation for use with a right hand door or for use with a left hand door by locating the respective jambs in relative positions for selectively either the left hand door or the right hand door;
the strike jamb including a first strike opening and a second strike opening, the two strike openings being spaced apart; and
the hinge jamb having hinge receiving structures being located such that a hinge receiving structure is located in an upper half of the hinge jamb and a hinge receiving structure is located in the lower half of the hinge jamb, such that the hinge operation is either:
(a) as hinges for each of an upper door or lower door respectively, or
(b) as hinges being for operation with a full door.

12. A door frame as claimed in claim 11 wherein the hinge jamb has two ends and the strike jamb has two ends, and wherein the side profile of each of the ends includes first end formations that are relatively symmetrical with each other thereby permitting the jambs to be used for a left hand door or a right hand door.

13. A door frame as claimed in claim 11 wherein the top jamb includes mating second formation for engagement with either one of the respective first formations of the hinge jamb and the strike jamb.

14. A door frame as claimed in claim 11 including an outer door frame structure wherein the cross sectional profile of the hinge frame and the strike frame is generally rectangular with an open side for location with an outer door frame structure, such that the frame structure fits with the jambs, and wherein there is a rectilinear-like protrusion against which a door face can be located.

15. A door frame as claimed in claim 11 wherein the ends of the strike jamb and the ends of the hinge jamb includes a notch, the notch being a first formation, the notch being for receiving a notch, being a second formation in the top jamb when the relative jambs are placed in assembled adjacent relationship together.

16. A door frame as claimed in claim 1 wherein the hinge jamb and strike jamb respectively have profiles at each end which are substantially similar, and whereby in a first situation the top end of a strike jamb and hinge jamb interengage with the top jamb thereby permitting for a door to open in a first direction, and in a second configuration the bottom of the strike jamb and the two ends are reversed and interengage with the top jamb such that the door opens in the opposite direction relative to the plane of closure, the plane of closure being defined as the normally closed position between the strike jamb, top jamb and hinge jamb.

17. A door frame as claimed in claim 6 wherein the hinge jamb and strike jamb respectively have profiles at each end which are substantially similar, and whereby in a first situation the top end of a strike jamb and hinge jamb interengage with the top jamb thereby permitting for a door to open in a first direction, and in a second configuration the bottom of the strike jamb and the two ends are reversed and interengage with the top jamb such that the door opens in the opposite direction relative to the plane of closure, the plane of closure being defined as the normally closed position between the strike jamb, top jamb and hinge jamb.

18. A door frame as claimed in claim 11 wherein the hinge jamb and strike jamb respectively have profiles at each end which are substantially similar, and whereby in a first situation the top end of a strike jamb and hinge jamb interengage with the top jamb thereby permitting for a door to open in a first direction, and in a second configuration the bottom of the strike jamb and the two ends are reversed and interengage with the top jamb such that the door opens in the opposite direction relative to the plane of closure, the plane of closure being defined as the normally closed position between the strike jamb, top jamb and hinge jamb.

19. A door frame for mounting selectively all of the following doors, the doors being a right hand door, a left hand door, a full door or a split upper door and lower door, wherein the door frame comprises
a top jamb, a strike jamb and a hinge jamb;
the strike jamb and the hinge jamb being symmetrical in cross section between the top and the bottom of each jamb thereby permitting installation for use with a right hand door or for use with a left hand door by locating the respective jambs in relative positions for selectively either the left hand door or the right hand door;
the strike jamb including a first strike opening and a second strike opening, the two strike openings being spaced apart such that the first strike opening is for use with a top door and the second strike opening is for use with a lower door, and wherein when there is a full door in the door frame either the first strike opening or the second strike opening is operable with the door;
the hinge jamb having hinge receiving structures being located such that two of the receiving structures are in an upper half of the hinge jamb and two of the hinge receiving structures are in the lower half of the hinge jamb, such that the hinge operation is either:
(a) as two hinges for each of an upper door or lower door respectively, or
(b) as at least two of the hinges being for operation with a full door;
wherein the hinge jamb has two ends and the strike jamb has two ends, and wherein the side profile of each of the ends includes first end formations that are relatively symmetrical with each other thereby permitting the jambs to be used for a left hand door or a right hand door; and
the two ends of the hinge jamb and the two ends of the strike jamb having symmetrical formations thereby permitting either end of the strike jamb and hinge jamb to engage with the respective end of the top jamb.

20. A method for mounting a door frame wherein the two ends of the hinge jamb and the two ends of the strike jamb have symmetrical formations thereby permitting either end of the strike jamb and hinge jamb to engage with the respective end of the top jamb.

21. A method of mounting a door frame for mounting selectively all of the following doors, the doors being a right hand door, a left hand door, a full door or a split upper door and lower door, wherein the door frame is formed by:
relating a top jamb, a strike jamb and a hinge jamb to each other, the strike jamb and the hinge jamb being symmetrical in cross section between the top and the bottom of each jamb;
installing with a right hand door or a left hand door by locating the respective jambs in relative positions for selectively either the left hand door or the right hand door;
providing a first strike opening and a second strike opening spaced apart such that the first strike opening is for use with a top door and the second strike opening is for use with a lower door;
operating a full door in the door frame either the first strike opening or the second strike opening; and
providing hinge receiving structures such that the hinge operation is either:
(a) as two hinges for each of an upper door or lower door respectively, or
(b) as at least two of the hinges being for operation with a full door.

22. A method for mounting door frame as claimed in claim 21 including providing the hinge jamb and strike jamb respectively with profiles at each end which are substantially similar, and whereby in a first situation the top end of a strike jamb and hinge jamb interengage with the top jamb thereby permitting for a door to open in a first direction, and in a second configuration the bottom of the strike jamb and the two ends are reversed and interengage with the top jamb such that the door opens in the opposite direction relative to the plane of closure, the plane of closure being defined as the normally closed position between the strike jamb, top jamb and hinge jamb.
